(19) United States
(12) Patent Application Publication
(10) Pub. No.: US 2010/0250669 A1
(43) Pub. Date: Sep. 30, 2010

(54) PORTABLE MEDIA DELIVERY SYSTEM WITH A MEDIA SERVER AND HIGHLY PORTABLE MEDIA CLIENT DEVICES

(76) Inventor: Yang Pan, Singapore (SG)

Correspondence Address: Yang Pan;Intellectual Power Pte Ltd, No. 14 Robinson Road #06-01,, Far East Finance Building, Singapore, 048545, SG

(21) Appl. No.: 12/794,780

(22) Filed: Jun. 7, 2010

Related U.S. Application Data
(62) Division of application No. 12/172,270, filed on Jul. 14, 2008.

(51) Int. Cl. G06F 15/16

(52) U.S. Cl. 709/203

(57) ABSTRACT

A media delivery system comprises a portable media server and a client device. The client device may be an audio player. The client device may also be an enabling part of the media server. A predetermined playlist of media assets is transferred from the server to the client when they are connected in a wired manner or in a wireless manner. Motion sensors such as accelerometers are integrated into earphones to control the operations of the audio player. In an exemplary case, the motion sensor in one of the earphone is used to increase the sound volume and the sensor in another earphone is used to reduce the sound volume.

### CROSS-REFERENCE TO RELATED APPLICATIONS

The present disclosure is a division of U.S. patent application Ser. No. 12/172,270.

### BACKGROUND

1. Field of Invention

This invention relates to a media delivery system, specifically to a portable media delivery system with a media server and highly portable media client devices.

2. Description of Prior Art

A portable media player stores media assets such as songs and video clips, which can be played on the device. Examples of media players are the iPod from Apple Inc. of Cupertino, Calif., the Zen from Creative Technology Ltd, Singapore and the Zune from Microsoft Inc of Redmond, Wash. A media player acquires typically its media assets from a computer with media management applications, such as the iTunes software from Apple. The portable media players have gained popularity because of its capability to store large number of media assets in a device, which can be put into a user's pocket when he or she is moving around. The large number of media assets are organized in a way of automatic hierarchical categorization by metadata as disclosed in U.S. Pat. No. 6,928,433 to Goodman and Egan. Portable media players with wireless communication capabilities have been disclosed by Fadell, et al in US Patent Publication 2008/0125031.

Despite of the gained popularity of the portable media players, there are two conflicting requirements for the device. On one hand, it is becoming popular to integrate multiple functions into a single handheld device. For example, an iPhone from Apple can be used as a mobile phone, as an internet connecting device, and as a media player. More functions in a single device typically demand a bulky battery to provide a reasonably long operation lifetime. On the other hand, the compactness of the device is a critical requirement for some users, in particular, when it is used for wearing to have a physical exercise. As a result of the conflicting requirements, different types of portable media players have been provided in the market for different applications. It is, however, not always convenient for a user to maintain multiple portable media products for different occasions when the same media database in a personal computer is maintained.

In US Patent Publication 2008/0013274, Jobs et al disclosed an art to have an improved portable media device. The device is small by eliminating the display screen. It was recognized by the inventors that a user would encounter difficulties to use a display screen integrated with a reduced size device. The compactness of the device, however, has not been fully achieved because of the presence of the visible user input devices.

Therefore, what is desired is a portable media device with even smaller size that is suitable for a user to carry to have a physical exercise. What is further desired is a portable media delivery system including a portable media server and highly portable client devices. The server may be a portable device such as the iPhone from Apple. The highly portable media client devices may be a stripped-down version of media device consisting of much reduced number of components. The client device is ideally a plug and play apparatus for the server. The client device receives selected media assets from the server.

Accordingly, it is a purpose of the present invention to provide a portable media delivery system including a portable media server and portable media client devices.

It is a further purpose of the present invention to provide an extremely compact audio player. The audio player does not require a display screen and a visible user input device to be functional.

It is yet a further purpose of the present invention to provide methods of using motion sensors in earphones to control the sound volume of an audio player.

### SUMMARY OF THE INVENTION

A portable media delivery system comprises a portable media server and at least one highly portable media client device. An audio player is used in an exemplary manner to illustrate the present inventive concept.

According to one embodiment of the present invention, the server and the client device may be two independent devices.

According to one aspect of the invention, the server and the client device are connectable through a convention wired connection such as through a Universal Serial Bus (USB) type of connection.

According to another aspect of the present invention, the portable media server and the client devices are connected through a wireless communication means. In such an implementation, multiple client devices may be connected to the server concurrently.

An audio player as an exemplary case of the client device may be a stripped-down version of a media player. The display screen and the user input devices are eliminated to further reduce the size of the device. The selected media assets transferred through the wired or the wireless connection from the portable media server are stored in a storage device such as a cache of the audio player.

According to another embodiment of the present invention, the audio player as an exemplary client device is a subsystem of the portable media server. The audio player may be detachable from the server. In such an implementation, the audio player as a part of the media server is connected to the host through a wired connection such as through the USB type of connector. The audio player, comprising a processor, a cache, a CODEC and a battery, is an integrated part of the portable media server. The cache stores selected media assets from the media file system of the server. When detached, the audio player is operated independently while the media server ceases to be functional.

The present invention further discloses methods for adjusting sound volume by utilizing of motion sensors. Because of this innovative feature, an audio player can be constructed without a display screen and without any visible user input device. The motion sensors, which are silicon accelerometers or gyroscopes in our preferred implementation, are embedded in earphones. Two accelerometers are used to adjust the sound volume. Each earphone contains one of the accelerometers. One is named as the ‘up-sensor’ to increase the sound volume and another as the ‘down-sensor’ to reduce the sound volume. The sound volume adjusting operation can be carried out by a user selecting one of the earphones and by holding the device at a hand and weaving the earphone repeatedly. The processor identifies if the signal comes from the up-sensor or from the down-sensor and controls an operation to adjust the sound volume accordingly. The two earphones with the opposite volume adjusting functions can be identified by the user with a different visual symbol on the surfaces of the earphones.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a portable media delivery system illustrating a wired and a wireless connection between a media server and media client devices.

FIG. 2 is a schematic functional block of a portable media delivery system with a portable media server and a highly portable media client device.

FIG. 3A is a simplified diagram of the synchronization of media files between different levels of media devices.

FIG. 3B is a simplified diagram of synchronization of media files between the portable media server and the highly portable media client device.

FIG. 4 is a schematic diagram of a portable media device with a detachable client device.

FIG. 5 is a schematic functional block of a portable media device with a detachable sub-system as an audio player.

FIG. 6 is a flow diagram of the method to use a pair of motion sensors embedded in earphones to control the sound volume of a media client device.

FIG. 7 is a flow diagram of the method to use a motion sensor embedded in the media client device to control the ‘pause’ and ‘restore’ operations.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

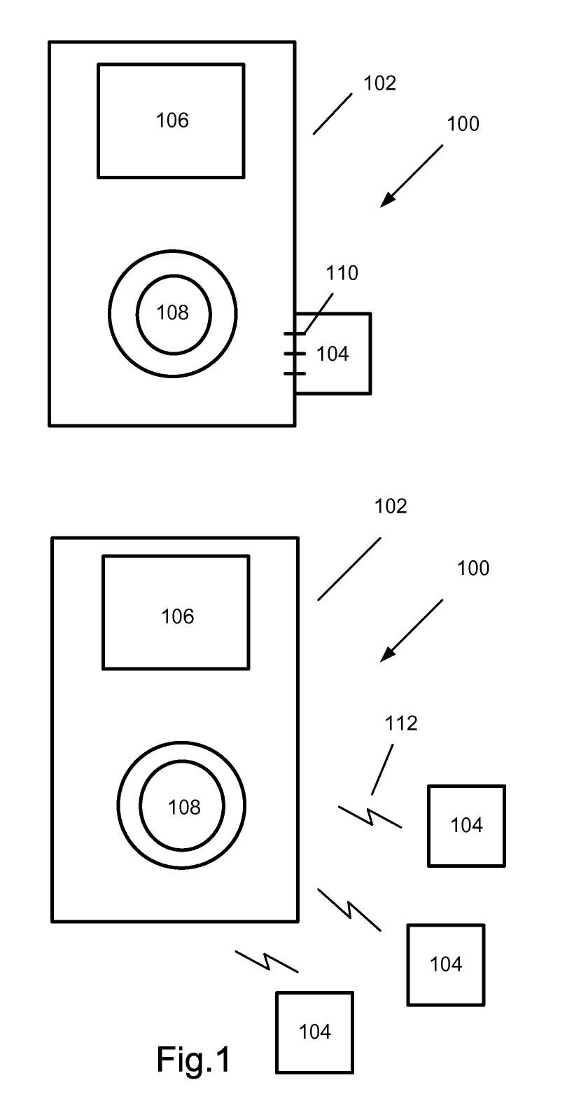

FIG. 1 shows a schematic diagram of a portable media delivery system 100. According to one embodiment, the portable media delivery system 100 includes a server 102 and a media client device 104. The portable media server further comprises a user interface unit 106 such as a LCD (Liquid-Crystal-Display) screen and a user input device 108 such as a rotational user interface used in an iPod from Apple. The connection 110 between the two devices includes an USB type of connection in an exemplary case. The client device 104 may include a peripheral bus connector that enables the portable client device to connect to a peripheral bus port operatively coupled to the portable media server 102. The client device 104 can, therefore, communicate with the media server 102 without using cables or other support devices. The client device 104 is a plug and play device. The USB type of connector 110 as known in the art includes both power and data functionality, thereby allowing both power delivery and data communication to occur between the client device 104 and the portable media server 102. In some cases, the portable media server 102 powers or charges the client device 104 when connected.

According to another embodiment, the portable media server 102 and the client devices 104 are connected through a wireless means 112 by using the wireless network interfaces. The data may be transmitted between the media server 102 and the client devices 104 through a wireless link that conforms to various IEEE standards such as IEEE 802.11 (Wi-Fi), IEEE 802.15.1(Bluetooth) and IEEE 802.15.4 (Zigbee). It should be noted that many client devices 104 can be connected to the portable media server 102 concurrently when connected wirelessly.

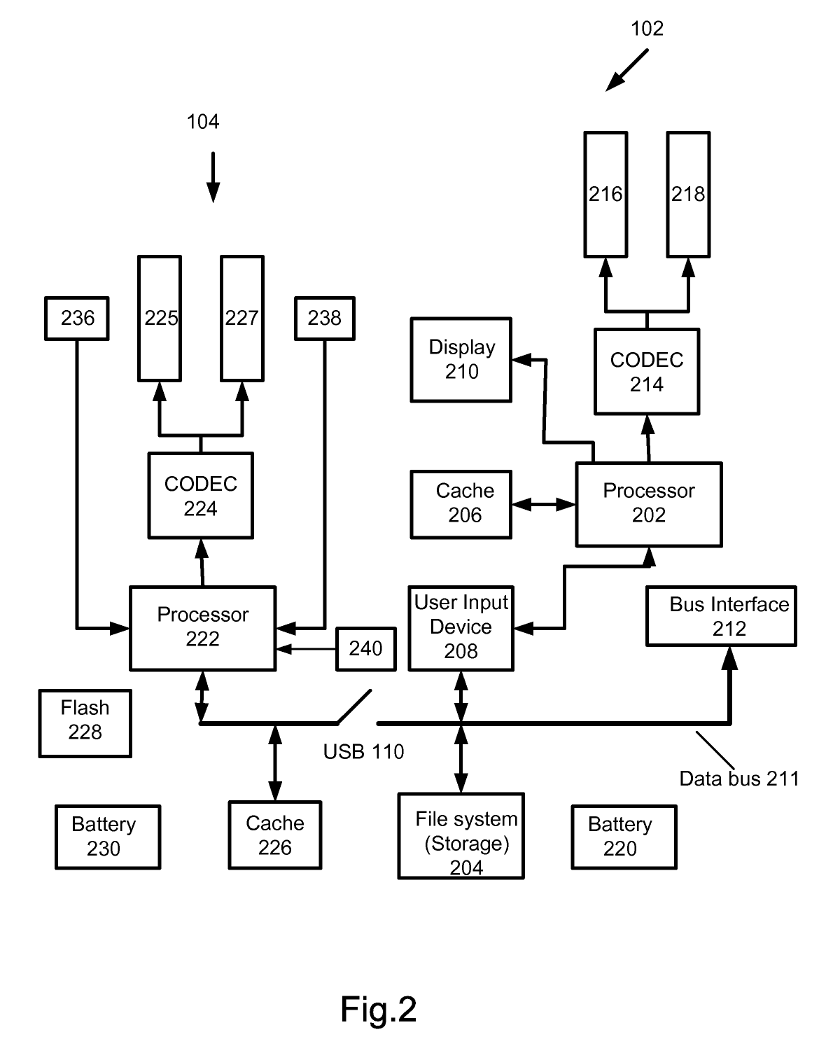

FIG. 2 is a schematic functional block of a portable media delivery system 100 with a portable media server 102 and a highly portable media client device 104. The portable media sever 102 is a media player in an exemplary case, including a processor 202 that pertains to a microprocessor or a controller for controlling the overall operation of the media player 102. The media player 102 stores media data pertaining to media assets in a file system 204 and a cache 206. The file system 204 is, typically, a flash memory or a plurality of flash memories or a storage disk or a plurality of disks. The file system 204 typically provides high capacity storage capability for the media player 102. However, since the access time to the file system 204 is relatively long, the media player 102 can also include a cache 206. The cache 206 is, for example, Random-Access Memory (RAM) provided by semiconductor memory. The relative access time to the cache 206 is substantially shorter than for the file system 204. However, the cache 206 does not have the large storage capacity of the file system 204. Further, the file system 204, when active, consumes more power than does the cache 206. The power consumption is particularly important when the media player 102 is a portable media player that is powered by a battery 220.

The media server 102 further includes a user input device 208 that allows a user of the media server 102 to interact with the device. For example, the user input device 208 can take a variety of forms, such as a button, keypad, dial, etc. Still further, the media server 102 includes a display 210 (screen display) that can be controlled by the processor 202 to display information to the user. A data bus 211 can facilitate data transfer between at least the file system 204, the cache 206, the processor 202, and the CODEC 214. The media server 102 also includes a bus interface 212 that couples to a data link (not shown). The data link allows the media server 102 to couple to a host computer.

The media server 102 serves to store a plurality of media assets (e.g., songs) in the file system 204. When a user desires to have the media server play a particular media asset, a list of available media assets is displayed on the display 210. Then, using the user input device 208, a user can select one of the available media assets. The processor 202, upon receiving a selection of a particular media item, supplies the media data (e.g., audio file) for the particular media item to a CODEC 214. The CODEC 214 then produces analog output signals for a pair of earphones 216 and 218.

The media client device 104 is a stripped-down version of an audio player in an exemplary case, including a processor 222, a CODEC 224, a cache 226 and a pair of earphones 225 and 227. At least one motion sensor, which is preferred as a silicon accelerometer, is packaged with each of the earphones. The silicon accelerometers manufactured by an integrated circuit based process is tiny and can be embedded into an earphone without increasing its size in a visible way. The sensor 236 is used to increase the sound volume and is named as ‘up-sensor’. The sensor 238 is used to reduce the sound volume and is named as ‘down-sensor’. It should be noted that the stripped-down version audio player 104 lacks of a display screen and a user interface device as used in the prior art. The sensors 236 and 238 with the opposite volume adjusting functions can be identified by the user with a different visual symbol on the surfaces of the earphones. For example, a red dot on an earphone 225 identifies itself for the adjusting up the volume and a green dot on the earphone 227 for the adjusting down the volume. Signals generated by the sensors and received by the processor 222 are used to control the sound volume of the earphones 225 and 227.

Yet another motion sensor 240 that is a silicon accelerometer in our preferred embodiment can be integrated into the audio player 104 to provide means to ‘pause’ or ‘restore’ the playing operation of the device. When a user decides to ‘pause’ the playing of a song by the audio player 104, one weaves the player beyond a normal way what a player could be moved during a physical exercise, i.e. the user weaves the device with a sufficient number of times beyond the normal vibration resulting from a typical physical exercise. Similarly, the user can ‘restore’ the playing operation if one weaves the player while the player is in the sleep mode.

According to another implementation of the present invention, the motion sensors may be a directional motion sensor. The directional motion sensor can detect the motion of an object along specific directions. Multiple accelerometers may be used and installed with specific arrangement as known in the art for such an implementation.

A power supply 230, which is typically a rechargeable battery, is used to provide power for the audio player 104 including the mentioned motion sensors 236, 238 and 240. A flash memory 228 is optional for the device 104. The media files transferred from the portable server 102 are stored in the cache 226. If a flash memory 228 is added to the system, the media files may be stored in the non-volatile memory to prevent the loss of data if power supply is switched off.

A user selects a number of predetermined media assets (songs) and locates the selected playlist into a specific output folder. The number of media assets associated with the playlist located in the output folder is typically much smaller than that of the media assets stored in the file system 204 of the portable media server 102. When the audio player 104 is plugged into an open USB slot 110 of the server 102, the processor 202 detects such an external device and sends a control signal to the cache 226 to clear up the stored media assets if any. The processor 202 then sends another control signal to the file system 204. The processor 202 selects the first media asset according to the playlist in the output folder from the file system 204 and sends the file to the cache 226 directly via data bus 211. The media assets associated with the playlist are selected sequentially and are sent to the cache 226 one after another. The received media assets in the cache 226 are stored following the same playlist in the server 102. The transferring of a selected media asset from the media server 102 to the multiple client devices may also be carried out via wireless connections in a similar manner, where the media assets are transmitted from a transceiver in the server and received by transceivers associated with each of multiple client devices. The received data will be decoded and be stored in the cache of the client devices.

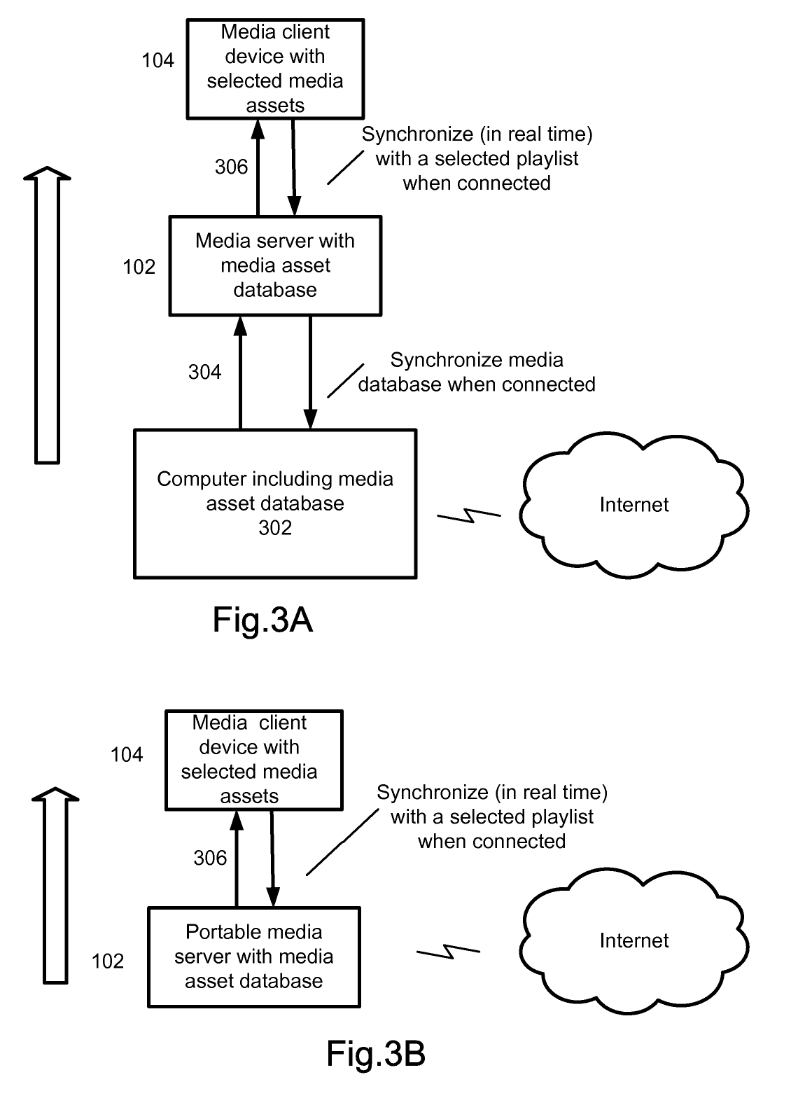

FIG. 3A is a simplified schematic diagram of the synchronization of media files between different levels of media devices. The portable media server 102 receives, typically, media assets from a database located in a computer 302 that usually connects to the internet. For example, an iPod or an iPhone receives its media assets from a database managed by the software product iTunes from Apple. The synchronization operation 304 is carried out by connecting the portable media server 102, which is a portable media player in an exemplary case, with the computer via a FIREWIRE (IEEE 1394 type of connection). The portable media server 102 receives a media asset database from the computer 302 and stores the assets in the file system. The media assets in the portable media client device 104 can be synchronized with the assets in a selected folder of the media server 102 in a real time base (306). The client device 104 receives a small number of selected media assets from the media server 102 and stores the data in its storage system such as the cache. The other media information such as the mode of the playlist can also be sent to the media client device 104 and be received by a processor in the device.

The user may further modify the playlist while the media server 102 and the media client device 104 are connected and the selected media assets are being transferred. In such a circumstance, the newly added media assets are listed one after another from the bottom of the existing playlist. Since the transferring of the associated media assets to the cache of the audio player is sequential, the operation of adding new items to the playlist does not affect the transferring the existing playlist to the cache. Moreover, as long as the new items are added and as the transferring of the existing media assets is completed, the newly added media assets are transferred immediately to the client device. On the other hand, if the user deletes existing items in the playlist from the media server 102, the associated media assets are then removed from the cache 226 of the client device 104 if they have already been received. The operation can be controlled by the processor 202 in the media server 102, which controls the operation of the client device 104 via the connected data bus. The synchronization, therefore, is on real time base. The client device 104 may be detached immediately after the user completes selection of the playlist and the processor 202 confirms that the received media assets in the client device 104 matches the latest playlist in the server 102.

When the client devices 104 are connected to the media server 102 wirelessly, the method of the real time synchronization remains the same except that the data is transferred via the wireless links rather than via the connected data bus. In such an implementation, more than one of client devices can be connected to the server and can receive the transferred media assets concurrently.

FIG. 3B is a simplified schematic diagram illustrating the synchronization between the portable media server 102 and the portable media client device 104 while the portable media server is connected to internet directly. The computer is not required in such an implementation as a media server storing the media asset database.

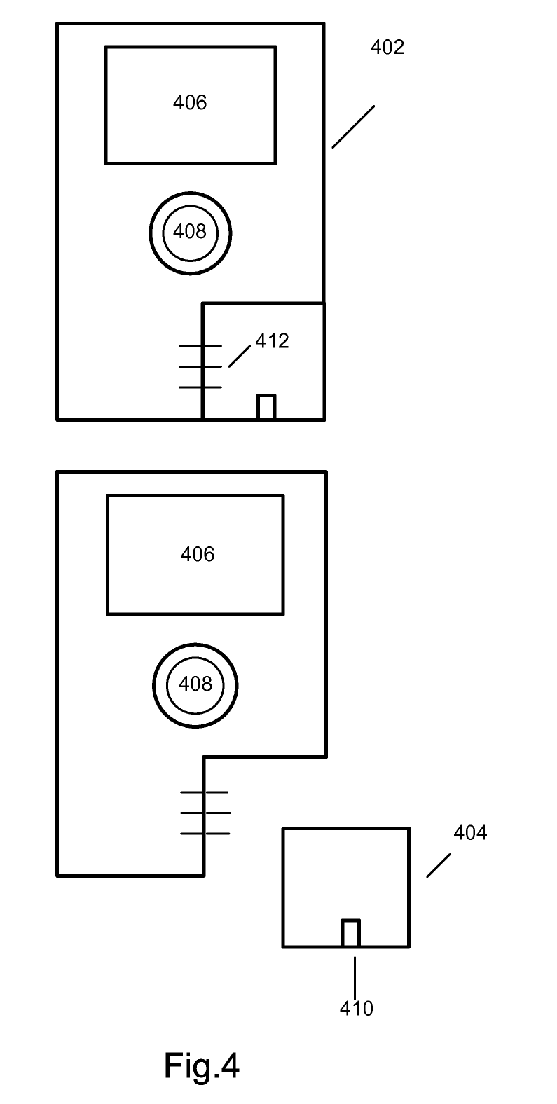

FIG. 4 shows a diagram of another embodiment of a portable media server 402, where the client device 404 is an integrated and yet detachable part of the media server 402. The media server includes a display screen 406 and a user input device 408. An earphone jack 410 is located at an edge portion of a house for the client device 404. The connector 412 connects the two units together in a conventional way including a means of USB type of connection.

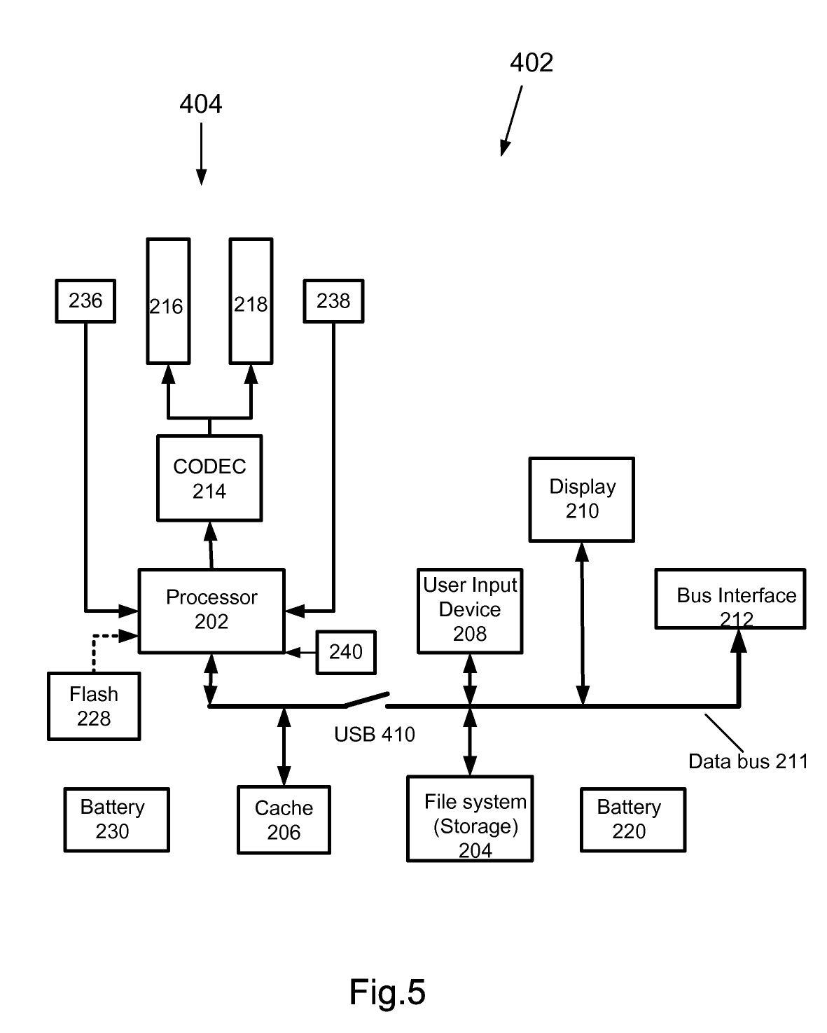

FIG. 5 shows a schematic functional block of a portable media server 402 with a detachable client device 404. When the two units are connected through the USB type of connector 410, the media server 402 is functioning as a conventional media player including all required functional blocks such as the processor 202, the file system 204, the cache 206, the user input device 208 and the display 210. The detachable client device 404 comprises part of the functional blocks of the media server with a processor 202, a cache 206, a CODEC 214, and a pair of earphones: 216 and 218. In addition, two motion sensors 236 and 238 that are silicon accelerometers in our preferred implementation are added into earphones 216 and 218, respectively. Another motion sensor 240 that includes at least one accelerometer is also added to the client device 404. An additional rechargeable battery 230, typically, much smaller than the battery 220 is included in the client device 404 to provide power supply. When two units are connected, the battery 220 may provide power to charge up the battery 230 through the USB type of connection. In yet another aspect of the invention, the battery 220 is located with the detachable audio player 404. The battery 230 is not required in such an implementation.

A user selects a number of predetermined media files (songs) and locates the selected playlist into an output folder. The number of media assets associated with the playlist located in the output folder is typically much smaller than that of the media files stored in the file system of the portable media sever 402. In the current embodiment, the media assets associated with the playlist are located in the cache 206. When a user detaches the client device 404 from the media server 402, the media assets stored in the cache 206 are detached and are moved with the client device 404 at the same time. A user can then operate the client device 404 as an independent media player after the separation. The remaining portion of the media server 402 then ceases to be functional.

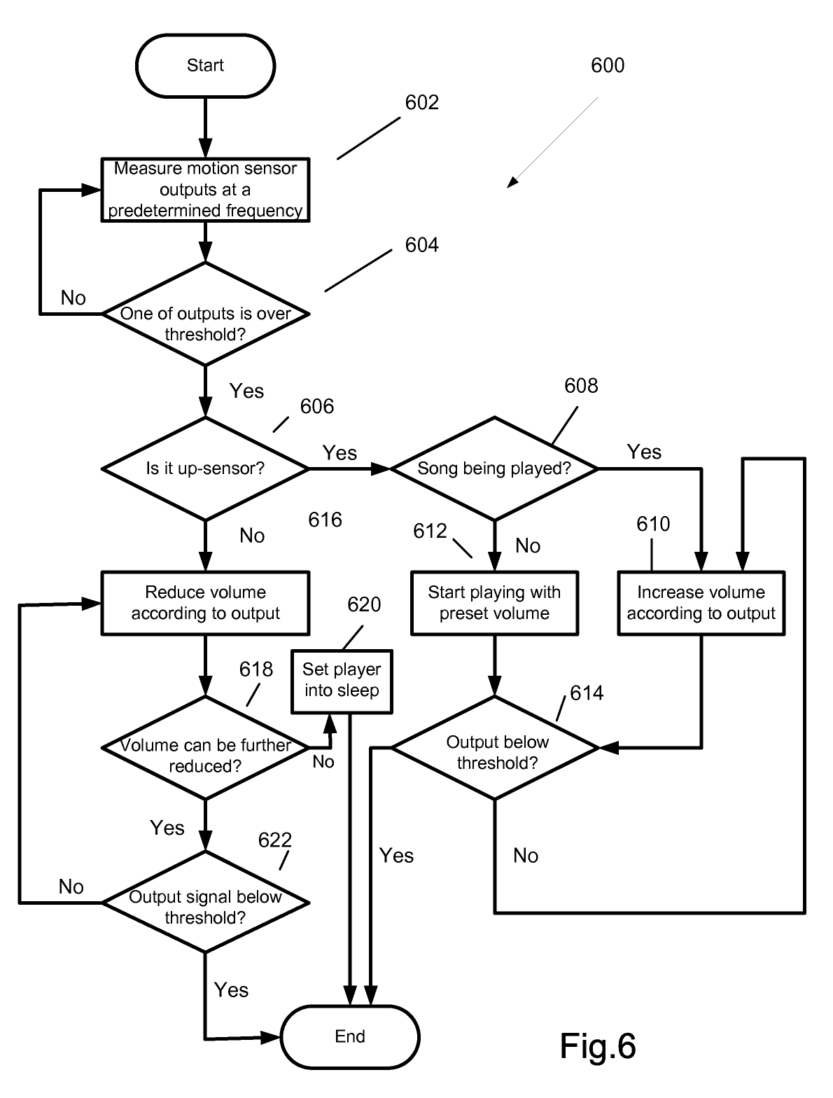

FIG. 6 is a flow diagram illustrating an operation of using a pair of motion sensors embedded in earphones to control the sound volume of an audio player. The motion sensors are accelerometers in the preferred implementation. The process 600 starts with measuring the output signals of motion sensors by a processor at a predetermined frequency (602). The output signal of a sensor is a digitalized electrical signal representing the motion of an earphone. The sensor embedded with the earphone delivers an output signal when the earphone moves with a change of speed, i.e. from the operation of changing the direction of motion. It is important that a threshold of the signal is defined that filters out all noises related un-intended movement, which is not related to any intended volume adjustment movement. An implementation is described herein for an explanatory purpose but not to limit the scope of the present invention. It should be noted that there are various variations to set the threshold for the motion sensors from the current description. When a user weaves an earphone with an embedded accelerometer, the sensor gives out an output signal with the nature of oscillation around a reference level. The threshold for the detection of a user's interaction, therefore, can be selected as the number of measured cycles of the signal with a sufficient amount of amplitude. The higher the number, the more reliable is for filtering out of the noise. In a practical application a cycle of two to three is sufficient to differentiate a signal from a noise.

The two sensors connected to the processor have a different peripheral identity associated with the ‘up’ or ‘down’ volume status. If the processor receives one of the sensors output signal in exceeding of the threshold as defined above (604), the processor decides the further action based upon the sensor's identity (606). If the processor detects the above threshold signal from the “up-sensor”, it checks weather a song is being played (608). The sound volume of earphones is increased according to the strength of the detected sensor signal if the processor confirms that a song is being played and the player is not in the sleep mode (610). Otherwise, the processor turns on the player from the sleep mode and starts to play a song according to the playlist (612). The processor checks the output of the sensor (614) continuously to detect if the ‘up’ signal is persistent after the operation. If the output signal from the sensor is persistent, the sound volume is increased further till the signal from the “up-sensor” is below the threshold.

On the other hand, if the processor detects an above threshold signal from the “down-sensor”, it controls an operation to reduce the sound volume of earphones based upon the strength of the detected signal (616). After the reduction of the sound volume, the processor checks if the volume can still be further reduced (618). If a negative response is received, the processor will make a decision that the user intends to switch off the player and the player will be set into the sleep mode (620). Otherwise the processor checks if the signal for reducing sound volume has been below the threshold after the operation (622). If the response is negative, the processor continues to adjust down the volume according to the strength of the signal from the “down-sensor” till either the received signals from the down-sensor is below the threshold or the player is set into sleep mode.

In an alternative implementation, the sound volume of the audio player may be adjusted by motion sensors in a single earphone. The motion sensors may be accelerometers or gyroscopes with specific installation as known in the art. The sensors are able to detect the motion of the earphone along different directions. According to such an implementation, one of the direction may be employed to increase the sound volume and another be employed to reduce the sound volume. The directions may be “up-down” and “right-left”. The directions may also be “up-down” and “front-back”. The directions may also be any other combinations with clear physical distinctions.

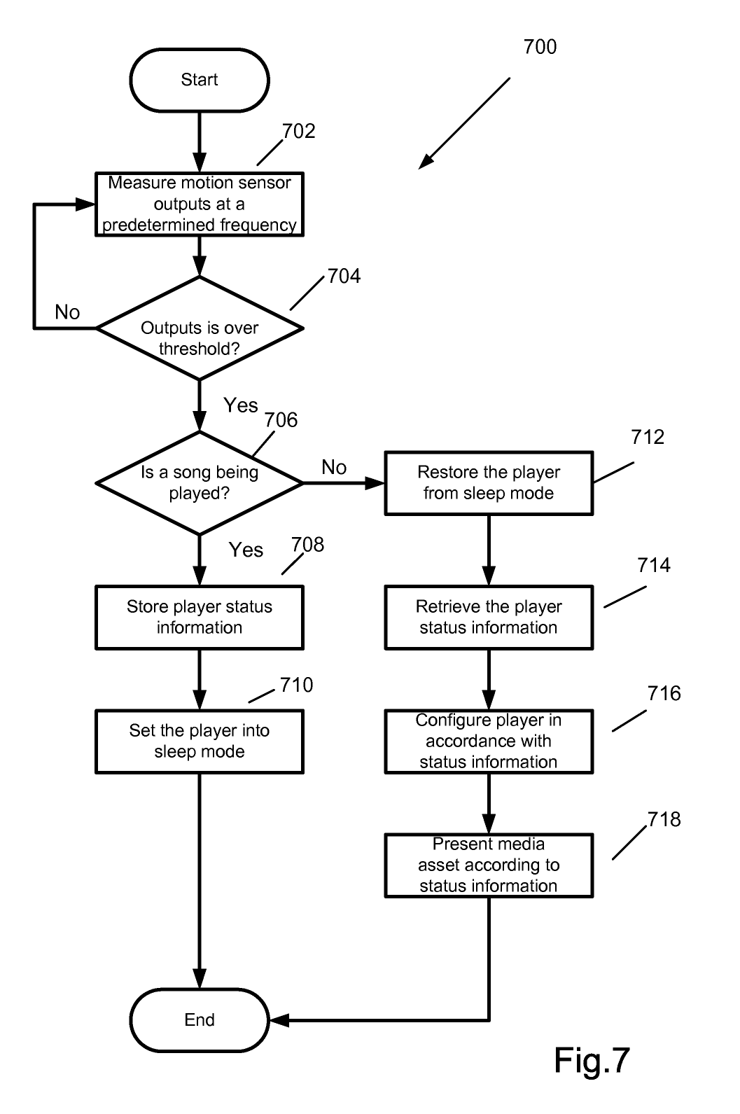

FIG. 7 is a flow diagram of a method to use a motion sensor (accelerometer) embedded in the audio player to control the ‘pause’ and ‘restore’ operations. The process 700 starts with measuring the output signal of the accelerometer by a processor at a predetermined frequency (702). The output signal of the sensor represents the movement of the player. If the output signal is in exceeding of the predetermined threshold (704), the processor further checks the status of the player (706). If a song is being played, the processor stores the media player status information (708) and then sets the player into sleep mode (710). Otherwise, the player has been in the sleep mode and the processor restarts the processor from the sleep mode (712) and retrieves the recorded player status information (714) and further configures the client device in accordance with the status information (716). The processor further presents media asset according to media player status information (718).

While the invention has been disclosed with respect to a limited number of embodiments, numerous modifications and variations will be appreciated by those skilled in the art. It is intended that all such variations and modifications fall with in the scope of the following claims:

1. A portable media delivery system, comprising a portable media player as a server and at least one stripped-down audio player as a client, wherein the playlist of the client and a selected playlist of the server are synchronized automatically when the server and the client are connected through a communication means.

2. The system as recited in claim 1, wherein said communication means comprising a wired connection.

3. The system as recited in claim 2, wherein said wired connection comprising a Universal Serial Bus type of connection.

4. The system as recited in claim 1, wherein said communication means comprising a wireless communication means.

5. The system as recited in claim 4, wherein the wireless communication means comprising:
a. IEEE 802.11 (Wi-Fi) and its amendments;
b. IEEE 802.15.1 (Bluetooth) and its amendments; and
c. IEEE 802.15.4 (Zigbee) and its amendments.

6. The system as recited in claim 1, wherein said portable media player further comprising a processor for controlling the operation of the server and the client when they are connected.

7. The system as recited in claim 1, wherein said strip-down version of audio player further comprising a processor, a CODEC, a cache and a pair of earphones.

8. The system as recited in claim 1, wherein said stripped-down version of audio player comprising no display screen and no visible input device and operations of the audio player are controlled by using motion sensors affixed to the earphones and the audio player.

9. The system as recited in claim 1, wherein said playlist in the portable media player may be predetermined before the server and the client are connected.

10. The system as recited in claim 1, wherein said playlist in the portable media player may be modifiable when the playlist is being transferred from the server to the client.

11. A portable media player, comprising a detachable sub-system as an enabling part, wherein said enabling part may be operated as an audio player when it is detached from the portable media player.

12. The portable media player as recited in claim 11, wherein said enabling part is connectable to the player through a wired connection including a Universal Serial Bus type of connection.

13. The portable media player as recited in claim 11, wherein said audio player comprising a processor, a CODEC, a cache and a pair of earphones.

14. The portable media player as recited in claim 11, wherein said stripped-down version of audio player comprising no display screen and no visible input device and operations of the audio player are controlled by using motion sensors affixed to the earphones and the audio player.

15. The portable media player as recited in claim 11, wherein a plurality of pre-selected media assets are stored in a storage device located in the enabling part of the portable media player, wherein said storage device further including a cache.

16. A method of transferring a plurality of media assets from a server to a client comprising:
a. selecting a plurality of media assets from a media asset database of the server;
b. placing the selected media assets into a predetermined folder as a playlist;
c. transferring the playlist to the client when the server and client connected;
d. modifying the playlist by adding new media assets and/or by deleting one or a plurality of existing media assets through a user interface of the server when the media assets are being transferred; and
e. transferring the newly added assets to the client and removing the deleted assets.

17. The method as recited in claim 16, wherein said steps of transferring the media assets from the server to the client may be accomplished by a processor in the server.

18. The method as recited in claim 16, wherein said transferred media assets may be stored in a storage device of the client including a cache.

19. The method as recited in claim 16, wherein said media assets may be transferred accompanying with transferring predetermined control parameters associated with the playlist.

20. The method as recited in claim 16, wherein said newly added media assets may be listed from the bottom of the playlist in a sequential manner.
